(19) United States
(12) Patent Application Publication
(10) Pub. No.: US 2007/0038563 A1
(43) Pub. Date: Feb. 15, 2007

(54) Systems and methods for managing buildings and finances

(76) Inventor: Eric Ryzerski, Somers, NY (US)

Correspondence Address: KALOW & SPRINGUT LLP, 488 MADISON AVENUE, 19TH FLOOR, NEW YORK, NY, 10022, US

(21) Appl. No.: 11/504,183

(22) Filed: Aug. 15, 2006

Related U.S. Application Data
(60) Provisional application No. 60/708,359, filed on Aug. 15, 2005.

(51) Int. Cl. G06F 17/30

(52) U.S. Cl. 705/40; 707/10

(57) ABSTRACT

In various embodiments, building management systems and methods are provided as a stand-alone, or network based system that utilizes integrated software that manages bills, consumables (e.g., oil, propane, water, electric, food, etc.), and appointments. In various embodiments, the building management system provides increased safety, security and convenience to a user.

This application claims the benefit of Provisional Application Ser. No. 60/708,359, filed Aug. 15, 2005, entitled “System For Managing Finances And Home Inventory ”, the entire disclosure is hereby incorporated by reference into the present disclosure.

### BACKGROUND OF THE INVENTION

Managing a building (e.g., home) can be a tremendous responsibility. There are numerous issues facing a building owner with respect to daily activities including maintaining and replenishing consumables, scheduling appointments and monitoring finances. At times, managing these daily activities can be stressful and an overwhelming responsibility.

Recently, many personal digital assistants (PDAs) have become popular for storing phone numbers and addresses, keeping track of schedules and expense reports, checking e-mail, or playing games of digital solitaire. However, while these assistants may be useful for certain purposes, they provide little benefit in managing building inventory and usage of consumables. For example, PDAs provide little assistance when a homeowner has an out of ordinary event occurring at home (e.g., water or gas leak) or in providing estimated usage of consumables based on seasonal need.

Although some PDAs may keep track of expenses, they are not adapted to pay bills online. If the PDA devices are lost or stolen, valuable information can be stolen and used in identity theft and credit card fraud.

There is a need for new building management systems and methods that take the stress out of managing a building. Systems and methods that provide services for automated bill payment, inventory management of utility levels (e.g., oil, propane, gas, water, etc.), and schedule management are needed. Systems that include user verification, and secondary credit card protection and verification are also needed.

### SUMMARY OF THE INVENTION

In various embodiments, the present invention provides a building management system as a stand-alone, or network based system that utilizes integrated software to provide a service for automated or manual bill payment, inventory monitoring of utility levels (e.g., oil, propane, gas, water, etc.) and schedule management. In various embodiments, systems and methods are provided for managing home or business inventory and usage of consumables (e.g., water, electricity, etc.) to prevent shortages by, for example, monitoring various tank levels and meters allowing interpretation of data to be used for various uses including building maintenance and repair.

The systems and methods, in various embodiments, avoid the need to write multiple checks to different providers and allow simple payment (various types e.g., direct deposit, check, credit card, smart card/wand, etc.) to replenish funds to the smart card account. In various embodiments, the systems and methods provide online security and prevent credit card fraud by employing user verification, and secondary credit card protection and verification.

In various embodiments, a computer based building management system is provided for managing a consumable, the system comprising: a user interface that displays options for a user to view some or all information about the consumable and manage the consumable, a database coupled to the user interface for storing some or all information about the consumable to manage the consumable; a processor coupled to the user interface and the database, the processor to receive and send information about the consumable to the database and the user interface; a provider interface coupled to the processor to send and receive an order from the user interface; and a control device that monitors the use of the consumable by sending information about the consumable to the processor.

In various embodiments, a computer based building management system for managing bills and/or appointments is provided, the system comprising: a user interface that displays options for a user to view some or all information about the bills and/or appointments, a database coupled to the user interface for storing some or all information about the bills and/or appointments; and a processor coupled to the user interface and the database, the processor to receive and send information about the bills and/or appointments to the database and the user interface; and a provider interface, the provider interface coupled to the processor to send and receive information about the bills and/or appointments to and from the user interface so that the user can manage the bills and/or appointments; wherein the user and/or the provider interface displays an alert as to a deadline for bill payment and/or appointment.

In various embodiments, a smart card is provided, comprising: a computer usable medium having computer readable and/or writable program code embodied therein configured to identify a user and/or provider at a user or provider interface of the system.

In various embodiments, a method is provided for managing a consumable, comprising providing: a user interface that displays options for a user to view some or all information about the consumable and manage the consumable, a database coupled to the user interface for storing some or all information about the consumable to manage the consumable; a processor coupled to the user interface and the database, the processor to receive and send information about the consumable to the database and the user interface; a provider interface coupled to the processor to send and receive an order from the user interface; and a control device that monitors the use of the consumable by sending information about the consumable to the processor.

In various embodiments, a method for managing bills and/or appointments is provided, the method comprising providing: a user interface that displays options for a user to view some or all information about the bills and/or appointments, a database coupled to the user interface for storing some or all information about the bills and/or appointments; and a processor coupled to the user interface and the database, the processor to receive and send information about the bills and/or appointments to the database and the user interface; and a provider interface, the provider interface coupled to the processor to send and receive information about the bills and/or appointments to and from the user interface so that the user can manage the bills and/or appointments; wherein the user and/or the provider interface displays an alert as to a deadline for bill payment and/or appointment.

In various embodiments, a computer based home management system for managing a consumable is provided, the system comprising: a user interface that displays options for a user to view some or all information about the consumable and manage the consumable, a database coupled to the user interface for storing some or all information about the consumable to manage the consumable; a processor coupled to the user interface and the database, the processor to receive and send information about the consumable to the database and the user interface; a provider interface coupled to the processor to send and receive an order from the user interface; and a control device that monitors the use of the consumable by sending information about the consumable to the processor; a second interface coupled to the processor to send and receive an order from the user interface, the second interface requesting identification from the provider via a smart card, the smart card comprising: a computer usable medium having computer readable and/or writable program code embodied therein configured to identify a provider at a second interface and authorize delivery of the consumable.

In various embodiments, a computer readable storage medium is provided for storing instructions that, when executed by a computer, cause the computer to display options for a user to view some or all information about a consumable and manage the consumable from a user interface by accessing a database coupled to the user interface, the database for storing some or all information about the consumable to manage the consumable; cause a processor coupled to the user interface and the database to receive and send information about the consumable to the database and the user interface; cause a provider interface coupled to the processor to send and receive an order from the user interface to manage the consumable; and cause a control device to monitor the use of the consumable by sending information about the consumable to the processor.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE FIGURES

FIG. 1 illustrates system architecture in accordance with one embodiment, where the building management system 10 is a stand alone computer system 30 having user interface 20, a database 32 coupled to the user interface; a processor 31 coupled to the user interface and the database, a provider interface 50 coupled to the processor 31 and/or control device 40; the control device 40 can be coupled to the computer and/or provider interface 50 that monitors the use of the consumable.

FIG. 2 illustrates a typical user and/or provider interface, which comprises, for example, a touch screen display.

FIG. 3 illustrates one embodiment of a welcome page for the building manager, where the user and/or provider enters their operator identification and their personal identification number to enter the system.

FIG. 4 illustrates a typical alert notification displayed on the user or provider interface about a consumable, in this case a leak occurring in the home.

FIG. 5 illustrates system architecture in accordance with one embodiment, where the building management system 10 is a server-based system 30 coupled to the user interface 20. The server 30 comprises database 32 and processor 31. Control device 40 is coupled to the server as well as provider interface 50 and card swipe 60. The control device 40 may be coupled to the provider interface 50.

FIG. 6 illustrates system architecture in accordance with one embodiment, where the building management system 10 is a web-based system employing the Internet 70. The building management system includes a server 30 coupled to the user interface 20. The server 30 comprises database 32 and processor 31 and can be coupled to the Internet, which can be coupled to the provider interface 50. User interface 20 can also be wireless and can be coupled to the Internet 70 via a wireless connection.

FIG. 7 illustrates, but is not limited to, the many functions the home management system can help the user perform.

FIG. 8 illustrates the information path in one embodiment of the building management system. Information about the consumable flows from the control device (e.g., a sensor) or provider to the home manager where the information can be sent to various providers.

FIG. 9 illustrates the information path in one embodiment of the home manager. Information about the fuel consumption is displayed on the user interface of the home manager. When the control device (e.g., sensor) detects low fuel, a notification is sent to the fuel company and the fuel company replenishes the fuel. An invoice is sent to the home manager and the user can make payment utilizing the home manager.

FIG. 10 illustrates the information path in one embodiment of the home manager when the consumable does not have a control device (e.g., a sensor) coupled to the home manager. The information regarding the consumable can be sent by various providers to the home management system.

FIG. 11 illustrates the information path in one embodiment of the home manager. Information about the low maintenance consumable is displayed on the user interface of the home manager. When the control device (e.g., sensor) sends a meter reading to the home manager, the homeowner has the option to pay the bill using the home manager. The transaction can be archived.

FIG. 12 illustrates a typical report generated by the home management system that tracks the history of usage of the consumable, in this case, oil usage.

FIG. 13 illustrates the home management system, where the user can access the home manager remotely (e.g., portal, cell phone, blackberry, etc.). The user or provider could send a command to other parts of the home management system.

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION OF THE INVENTION

Reference will now be made in detail to certain embodiments of the invention, examples of which are illustrated in the accompanying drawings. While the invention will be described in conjunction with the illustrated embodiments, it will be understood that they are not intended to limit the invention to those embodiments. On the contrary, the invention is intended to cover all alternatives, modifications, and equivalents, which may be included within the invention as defined by the appended claims.

It is noted that, as used in this specification and the appended claims, the singular forms “a,” “an,” and “the,” include plural referents unless expressly and unequivocally limited to one referent. Thus, for example, reference to “a user interface ” includes one, two, three or more user interfaces.

The headings below are not meant to limit the disclosure in any way; embodiments under any one heading may be used in conjunction with embodiments under any other heading.

In various embodiments, the building management system displays pertinent information such as bills due and paid, calendars, schedules, tank levels, etc. If an event occurs (e.g., fuel is low or bill is due) and action is needed, such as a bill payment or ordering a tank refill or service call, the building management system can be structured to respond, passively or actively.

In various embodiments, the building management system facilitates payment for goods and services utilizing electronic currency (e.g., a smart card, credit or debit card, etc.), which can be used at any interface. Alternatively, the user can set up the building management system to pay or respond automatically through pre-determined channels. Some advantages of the building management system include ease of transactions; safety and security in that a user does not have to give out personal information online, a user can consolidated bill payments, use existing technologies in home (i.e., personal PCs and Internet), and the building management system saves the providers time and money.

The building management system allows the management (e.g., planning, and allocation of resources to accomplish the set objectives) for the household inventory or consumable. It also allows the user to schedule and manage appointments and pay bills.

While many of the examples described refer to a home management or home manager, the specification is not meant to be limited to embodiments where the building is a home. Buildings include any structure intended for supporting or sheltering an individual. Buildings include commercial and/or residential buildings and or components of a building such as apartments.

In various embodiments, the building management system is used to manage a plurality of consumables in a plurality of building (e.g., primary home and second homes). Typically, the building manager can manage consumables at one or more of the same or different locations. Consumables include items the building or household uses over a period of time. Consumables include, but are not limited to, at least one of: oil, gas, propane, water, temperature, electric, cable, food, pet food, diapers, detergents, solar/wind electrical production and consumption, geo-thermal energy production and consumption, satellite communication or other items.

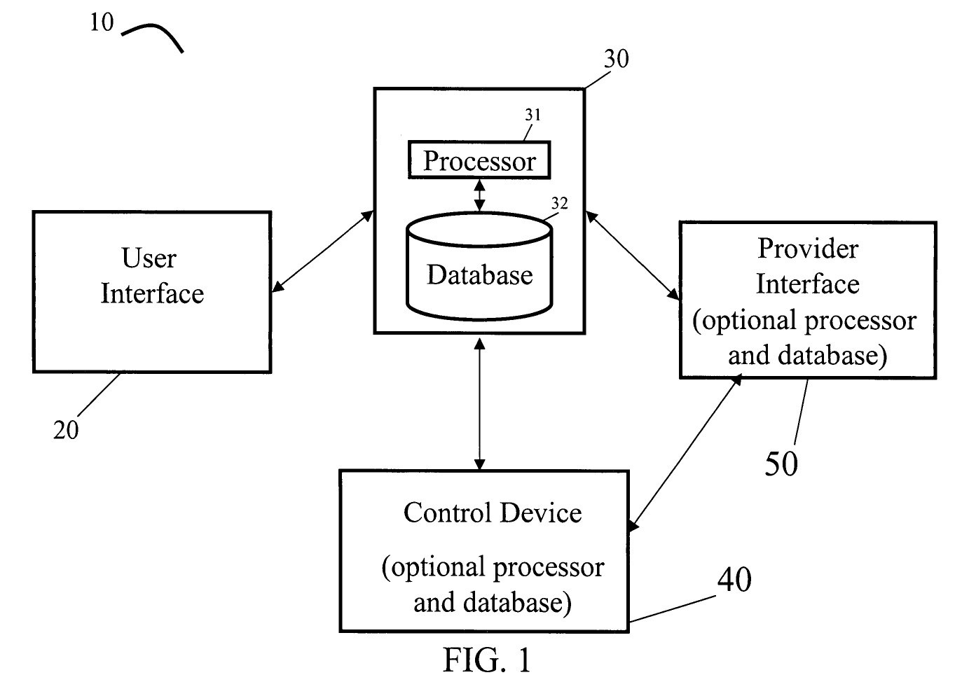

FIG. 1 illustrates system architecture in accordance with one embodiment, where the building management system 10 comprises a stand alone computer system having user interface 20 that displays options for a user to view some or all information about the consumable and manage the consumable; database 32 is coupled to the user interface for storing some or all information about the consumable to manage the consumable; a processor 31 coupled to the user interface and the database, the processor to receive and send information about the consumable to the database and the user interface; a provider interface 50 (that optionally comprises a processor and a database) coupled to the processor to send and receive an order from the user interface; and a control device 40 that monitors the use of the consumable by sending information about the consumable to the processor. Alternatively, the control device 40 may be coupled to the provider interface 50 so that the provider may send and receive information about the consumable and service the consumable directly without input from the user. However, the database 32 will store the transaction that occurs, so that the user or provider can access the information at the user and/or provider interface. User/Provider Interface

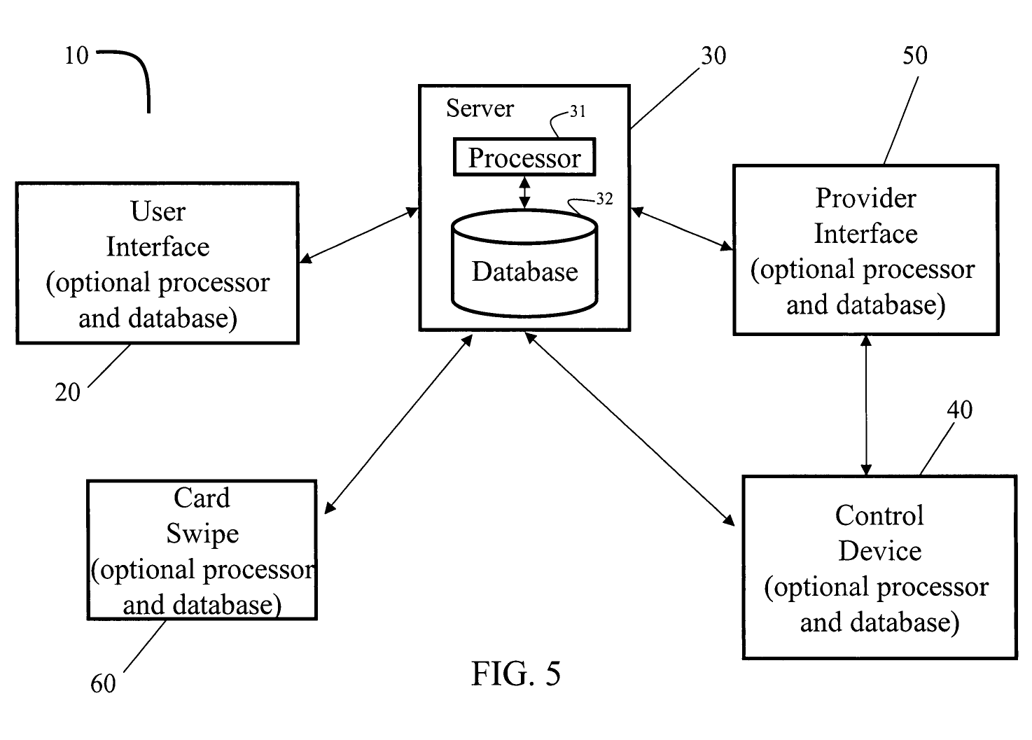

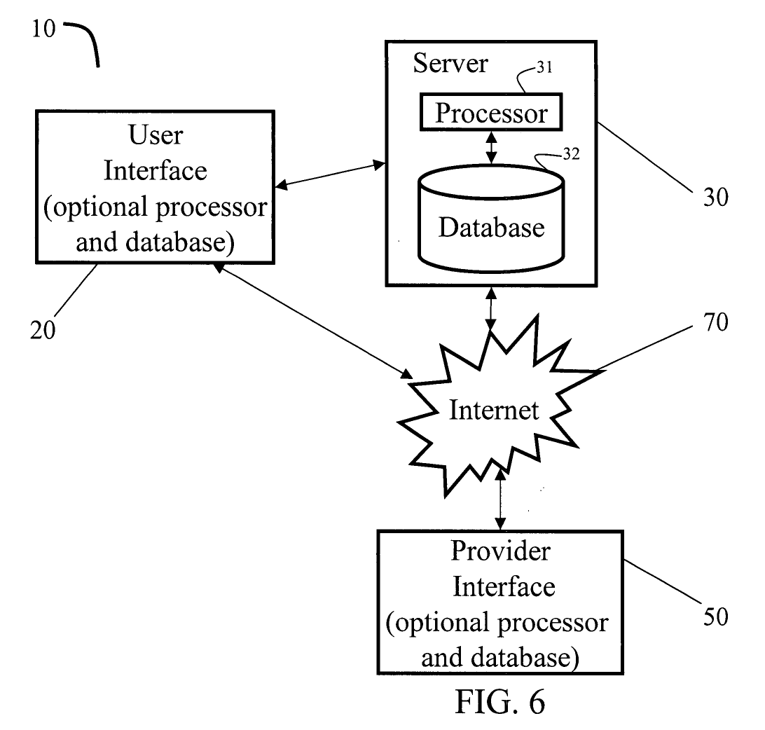

In accordance with an embodiment, one or more user interfaces and provider interfaces (e.g., user interface 20, provider interface 50 (FIG. 1) are provided as part of (or in conjunction with) the illustrated systems to permit users and/or providers to interact with the systems. User and/or provider interfaces may include one or more display devices (e.g., CRT, LCD, or other known displays) or other output devices (e.g., printer, etc.), and one or more input devices (e.g., keyboard, mouse, stylus, touch screen interface, card swipe, reader or other known input mechanisms) for facilitating interaction of a user or provider with the system via user interface 20 or provider interface 50. As illustrated, user interface 20 and/or provider interface 50 may be directly coupled to computer 30, or directly coupled to a network server system (30 in FIGS. 5 and 6). The coupling can be wired or wireless (e.g., wireless personal area networks e.g., Bluetooth, wi-fi, cellular, etc.).

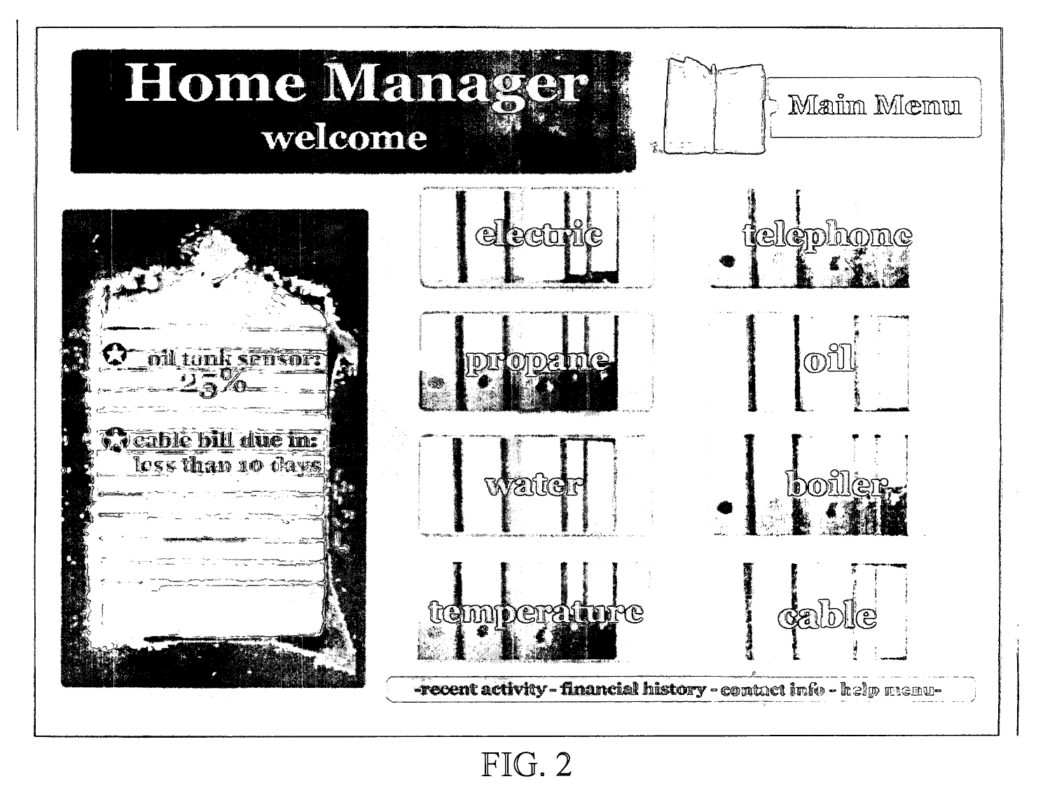

In various embodiments, the control device may be coupled to the provider interface 50, so that the provider can receive information about the consumable from the control device 40 (without input from the user interface 20 and/or building manager 30). FIG. 2 illustrates a typical user and/or provider interface, which comprises, for example, a touch screen display to view various information about the consumable, appointment and/or bill payment.

The user and/or provider interface may be implemented as a graphical user interface (GUI) containing a display or the like, or may be a link to other user input/output devices known in the art. Individual devices, or a plurality of devices (e.g., network/stand-alone computers, PDAs, WebTV (or other Internet-only) terminals, set-top boxes, cellular/PCS phones, screenphones, pagers, kiosks, blackberries, peer/non-peer systems or technologies or other known (wired or wireless or remote) communication devices, etc.) may similarly be used to execute one or more computer programs (e.g., universal Internet browser programs, dedicated interface programs, etc.) to allow a user and/or provider to interface with the systems in the manner described. It should be readily apparent that a “user” of the various aspects of the inventive systems or methods disclosed herein may be one or more individuals (e.g., including but not limited to, home owners, building owners, tenants, guests, building supervisors, managers, caretakers, maintenance companies, etc.), entities, including companies, businesses, without departing from the scope of the invention. A provider can be one or more individuals or entities that provide one or more services or provide one or more consumables to the user. Like users, the provider may be one or more individuals (e.g., including but not limited to building supervisors, managers, vendors, etc.), entities, organizations, companies, or businesses. Providers may also include entities that provide energy from natural resources, such as for example, solar and/or wind power.

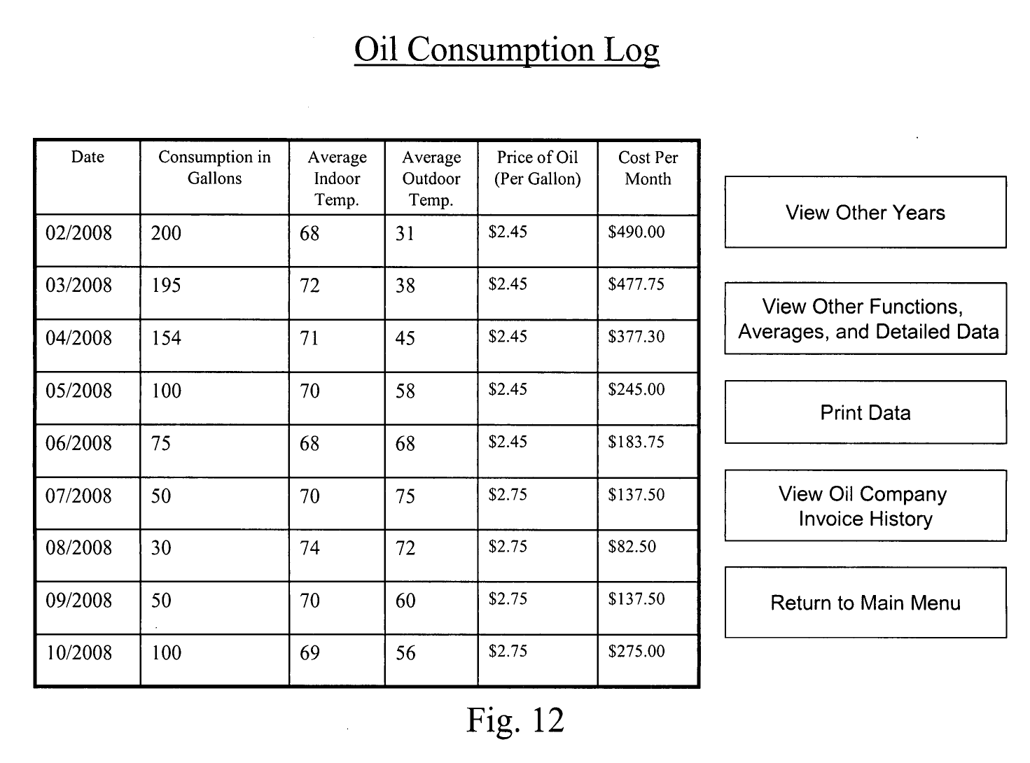

In various embodiments, the user or provider interface displays options for a user and/or provider to view some or all information about the consumable. In various embodiments, the user interface and/or the provider interface displays options for the user and/or provider to view consumable quantity, consumable usage, consumable usage pattern, and/or expenses of the consumable. FIG. 12 illustrates a typical report generated and displayed on the home manager system that tracks the history of usage of the consumable, in this case, oil usage.

In various embodiments, the user and/or provider can be assigned user identifiers, PIN, and passwords by the building manager or by the system administrator for the building manager. These reduce the chance of access by unauthorized users and/or providers. The building manager may also include security tokens, which request additional passwords or identification to access the building management system and/or other parts of the building manager and encryption programs that secure data against unauthorized access. The system administrator may be responsible for access and security of the building management system.

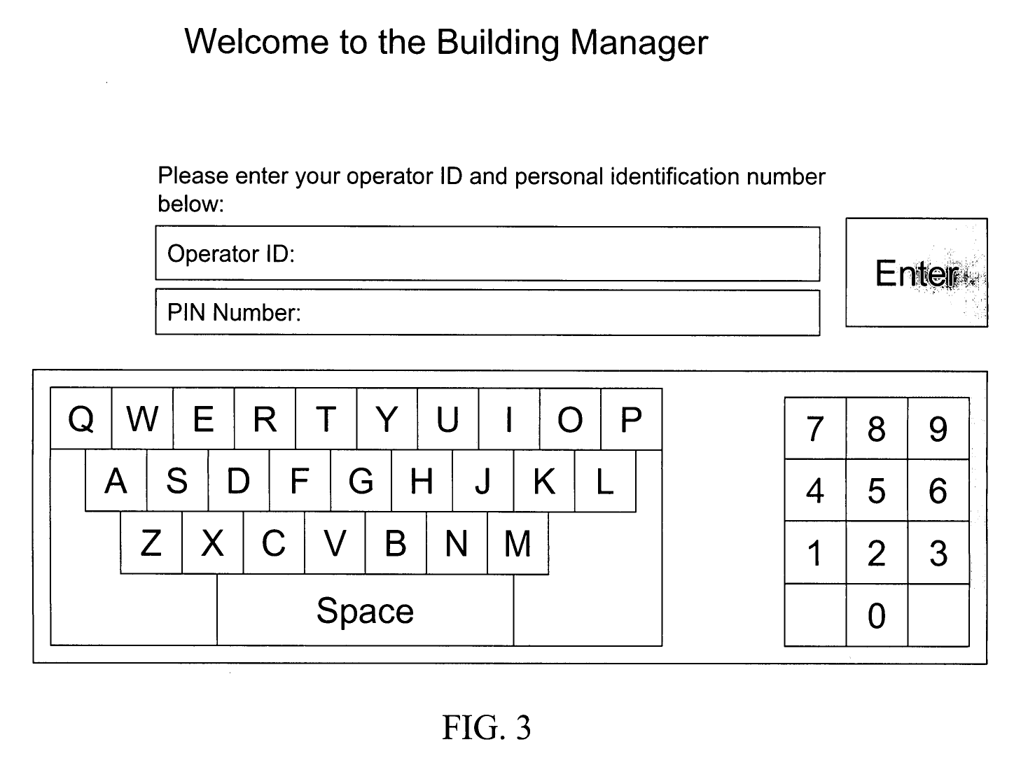

FIG. 3 illustrates one embodiment of a welcome page for the building manager, where the user and/or provider enters their operator identification and their personal identification number or password to enter the building management system.

Alert Generator

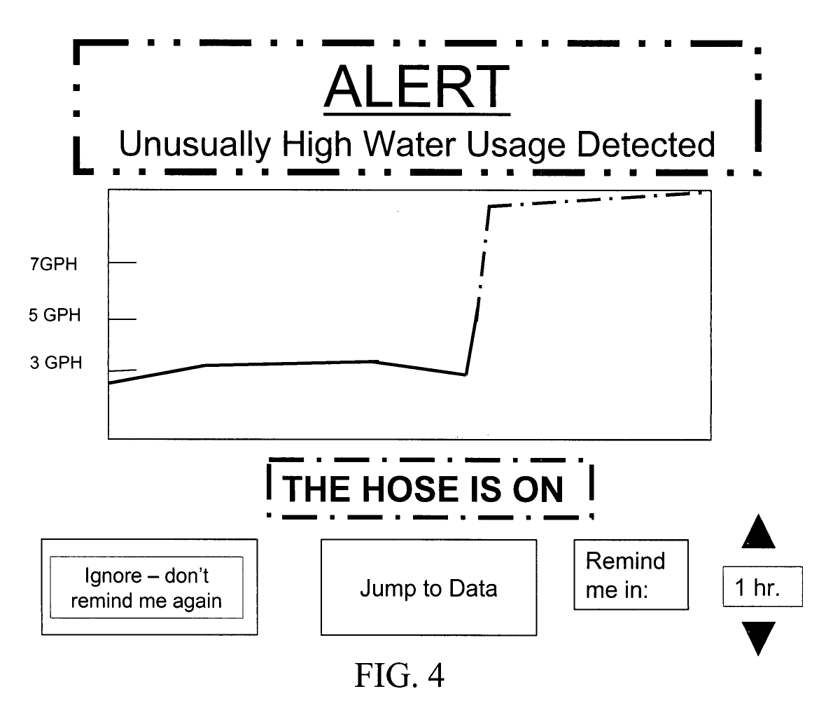

In various embodiments, the user and/or provider interface comprises an alert generator (alone or in conjunction with the database, processor, second interface) to access the saved information about the consumable, appointment and/or bill payment, and provide an alert at the user and/or provider interface upon occurrence of a predetermined event or computer expected model of usage (e.g., bill payment, bill deadline approaching, bill due or past due bill, a consumable delivery made, usage of a consumable drops below or is above a predetermined level or has started or stopped, time to order the consumable, etc.). The user and/or provider have the option to choose the options to set the alerts based on the control device and how to receive the alerts. For example, the alert generator can be programmed to provide an alert (e.g., water leak) to a user and/or provider by sending an e-mail or text message, voice mail message, pager message, facsimile message, regular mail message, or other mechanism (or combination of such mechanisms) specified by the user and/or provider. FIG. 4 illustrates a typical alert notification displayed on the user and/or provider interface about a consumable, in this case a leak occurring in the home. In various embodiments, the processor sends an alert to the user and/or provider by e-mail, phone, text message, pager, and/or fax.

In various embodiments, the building management system can be set to send to the user, provider, and/or second interface one or more reminder alerts particularly if prior alerts have been unanswered. For example, if alerts were ignored via e-mail, the building management system could now send alerts to the user, provider, and/or second interface by another route (e.g., pager, fax, telephone, etc.) till there is a response.

In various embodiments, the user and/or provider can set usage of the consumable to a predetermined level. For example, if the user has a second home and the temperature is at 68° C., the user can lower the temperature to 50° C. for a time when the second home is not in use. The home management system can be set to actively require input from the user and/or provider to take a specified action (e.g., deliver the oil, pay the bill, schedule an appointment, etc.) or the system may be set automatically, where for example the home manager will send a signal automatically when the consumable reaches a certain level to the provider (e.g., oil company).

In various embodiments, the provider interface and/or processor is configured to send and receive authorization to pay a bill, set an appointment, and/or send an invoice to the user interface. The provider interface may also be configured to send and receive electronic currency from a user's smart card and/or credit/debit card. Processor

The building management system comprises a processor 31 (FIGS. 1, 5 and 6), which typically executes one or more executable instructions or programs that instructs the building manager to perform the required function. The processor executes instruction and sends and receives information about the consumable, bill payment and/or schedule to the user and/or provider. For example, the processor can execute a command to show an alert at the user and/or provider interface that a consumable is low and the user can send a signal to the provider interface, which notifies the provider to schedule a delivery of the consumable to one or more specified locations.

It will be understood that the user interface, provider interface, control device, and or second interface can include one or more processors and databases to expedite communication among the various interfaces of the building management system.

In various embodiments, the processor is configured with an interpretation component to interpret the information received from the control device and send a signal to the control device, user, second and/or provider interface to take the appropriate action. Typically, the processor can start, stop, increase and/or decrease the usage of the consumable as directed by the control device, user, provider and/or second interface. For example, in the case of a gas leak the control device will monitor a surge of gas and send a signal to the processor. The processor will execute a command automatically and send a signal to the control device to turn off the consumable. Alternatively, the processor will send a signal to the user, provider and/or second interface (e.g., an alert) about the usage and the provider, user and/or second interface will send a signal back to the processor to execute a command to turn off the consumable or the provider will go to the home or building and turn off the consumable.

In various embodiments, the processor is configured to request identification from at least one user and/or provider to verify authorization to submit or receive an order. The requested information may be in the form of a password, PIN number, user identification security tokens, smart card or the like.

The processor, database, user, provider, and/or second interface, and/or control device, particularly those illustrated or inherent in the instant disclosure, may be one or more hardware, software, or hybrid components residing in (or distributed among) one or more local or remote computer systems. Although the processor, database, and user interface may be shown or described herein as physically separated components (e.g., user interface 20, processor 31, database 32, etc.), it should be readily apparent that these components as described herein may be merely logical constructs that are implemented as physical components combined or further separated into a variety of different components, sharing different resources (including processors, memory devices, software routines, etc.) as required for the particular implementation of the embodiments disclosed.

In various embodiments, the building management system may have the user interface, control device, processor, database, provider interface and/or second interface all at the same location or each at different locations. For example, the user interface, database and processor may be at one location, while the provider interface and the second interface and the control device are each at different locations.

Database

The building management system comprises database 32, which may be any one or more of the known storage devices or systems (e.g., Random Access Memory (RAM), Read Only Memory (ROM), hard disk drive (HDD), floppy drive, zip drive, compact disk-ROM, DVD, bubble memory, data sticks, redundant array of independent disks (RAID), network accessible storage (NAS) systems, storage area network (SAN) systems, compressed audio (e.g., MPEG-1, MPEG-2, MP3) or video data. The database may also be one or more memory devices embedded within a processor, or shared with one or more of the other components, and may be deployed locally or remotely relative to one or more components interacting with the memory or database. Database 32 stores some or all information about the consumable, bill and/or appoint information to manage. For example, the database may store information about consumable quantity, consumable usage, consumable usage pattern, and/or expenses of the consumable. In various embodiments, the database stores information on bill payment and/or appointment schedules.

Control Device

Control device 40 of the building management system is coupled to the computer or server 30 (FIGS. 1, and 5). In alternative embodiments, the control device 40 may be coupled to the provider interface. The control device may be one or more hardware, software, machine, or equipment, or hybrid components residing in (or distributed among) one or more local or remote computer systems which monitors the use of the consumable by sending information about the consumable to the processor, user, provider, and/or second interface. The control device can be set so that if an event occurs (e.g., a consumable delivery was made, usage of a consumable drops below or is above a certain level or consumable usage has started or stopped, etc.) a signal is sent to the processor, database, user, provider and/or second interface.

In one embodiment, the control device comprises one or more sensors that monitor the use of the consumable by sending information about the consumable to the processor, database, user, provider and/or second interface. Typically, sensors respond to changes in the environment, (e.g., changes in temperature, pressure, fluid level, etc.). The sensor will then transmit a signal to the processor, database, server, user, provider, and/or second interface, which can alert the user and/or provider about the change in the consumable. Some examples of sensors include, for example, RF sensor devices, oil, gas, water, electric, propane, boiler, temperature, and/or pressure sensors. Centeron™ is one company that makes oil and propane sensors suitable for use in various embodiments of the present invention. The sensor can accommodate the ever-changing household or building needs of the consumable.

Second Interface

In various embodiments, one or more second interfaces are coupled to the processor to receive authorization from the user and/or provider to replenish the consumable. In various embodiments, the second interface is separate from the user and/or provider interface and may be at the same or different locations. For example, the second user interface can be a card swipe or pay pass at the home, in which the provider can swipe or touch a smart card and receive authorization to replenish a consumable or the user can swipe his/her smart card and authorize delivery of the consumable to the home. In other embodiments, the second interface is a remote interface that can send and receive signals to and from the user and/or provider interface, where the user and/or provider can swipe his/her smart card at the second user interface and access information concerning the consumable (e.g. usage of the consumable), schedule an appointment, and/or pay a bill.

FIG. 5 illustrates a building management system architecture in accordance with one embodiment, where the building management system is a server-based system 30 coupled to the user interface 20. The server 30 comprises database 32 and processor 31. Control device 40 is coupled to the server as well as provider interface 50 and a second interface (e.g., a card swipe 60). In various embodiments, the control device 40 may be coupled to the provider interface 50, so that the provider can access the control device directly.

In accordance with another embodiment, optionally one or more second interfaces are provided as part of (or in conjunction with) the illustrated systems to permit users and/or provider to interact with the systems. The one or more second interface may include one or more display devices (e.g., CRT, LCD, or other known displays) or other output devices (e.g., printer, etc.), and one or more input devices (e.g., keyboard, mouse, stylus, touch screen interface, card swipes or other known input mechanisms) for facilitating interaction of a user or provider with the building management system. As illustrated in FIG. 5, second interface 60 (depicted as a card swipe) may be directly coupled to network server system 30. The coupling can be wired or wireless.

The second interface may be implemented as a graphical user interface (GUI) containing a display or the like, or may be a link to other user and/or provider input/output devices known in the art. Individual or a plurality of devices (e.g., network/stand-alone computers, PDAs, WebTV (or other Internet-only) terminals, set-top boxes, cellular/PCS phones, screenphones, pagers, kiosks, blackberries, peer/non-peer systems or technologies or other known (wired or wireless or remote) communication devices, etc.) may similarly be used to execute one or more computer programs (e.g., universal Internet browser programs, dedicated interface programs, etc.) to allow a user and/or provider to interface with the systems in the manner described.

In accordance with one embodiment shown in FIG. 6, the building management system 10 utilizes network server 30, which may be serving one or more user interfaces 20 and/or provider interfaces 50 over a collection of remote and disparate networks (e.g., Internet 70, intranet, VPN, etc.). Server 30 includes processor 31 and database 32. In one embodiment, the building management system 10 includes web browsers that are accessible to the users and/or providers via the Internet. The network server 30 can be coupled to the Internet 70 through many interfaces including but not limited to a local area network (LAN) or a wider area network (WAN), dial-up connection, cable or DSL modems or special high-speed ISDN lines. In various embodiments, user interface 20 can also be wireless and can be coupled to the Internet 70 via a wireless connection.

In various embodiments, a network server system 30 is employed coupled to database 32. Database 32, may include a search and collection component for searching and collecting information from users and providers and storing it in the database, a tracking component may also be included in the database to track information regarding the consumable, appointment and/or bill payment that can be displayed on the user interface 20 and/or provider interface 50 or at a second interface. Database 32 may also include a receiving component to receive a specific query from a user and/or provider interface (20 or 50), processor 31, control device, and/or second interface. The processor can receive queries and then store, search and collect the information from the database concerning the consumable, scheduled appointment and/or bill payment. The information then can be retrieved by the processor and stored in the database, and then sent to the user, provider and/or second interface.

Reports

The building management system may comprise a reports generator (alone or in conjunction with the processor, database, user interface, provider interface, and/or second interface) in providing reports regarding the consumable, schedules and/or billing information or other pertinent information as customized by a user and/or provider. Reports generator, for example, may be programmed to allow users and/or providers to create and store templates or other forms to be populated during report generation. Reports may then be generated manually or automatically from selected information (e.g., oil usage, electricity usage, cable usage, etc.). These reports may be printed or sent to the user or provider (e.g., via e-mail, fax, regular mail, courier, etc.) in any desired format (e.g., print, storage on electronic media such as CD-ROM, etc.). Alternatively, the report can be viewed on the user, second, and/or provider interface. In various embodiments, the building management system allows the user and/or provider interface to generate reports concerning past usage and/or bill payments for the consumable or allows the provider to send an invoice to the user interface for payment.

FIG. 12 illustrates a typical report generated by the building manager system that tracks the history of usage of the consumable, in this case, oil usage. The report is displayed on the user and/or provider interface and can list the archived or stored consumable information regarding one or more consumables. In FIG. 12, the date and consumption of oil is indicated from data transmitted from the oil sensor as well as average indoor and outdoor temperature indicated from the temperature sensors. Cost information is also provided and gathered from past invoices or from day to day prices provided by the provider interface. In FIG. 12, the user interface, gives the user the option to print the report, view other functions or view the provider's (oil company) invoice history.

In accordance with another embodiment, information (e.g., consumable, alerts, schedule and/or bill information) may be downloaded in one or more textual/graphical formats (e.g., RTF, PDF, TIFF, etc.), or set for alternative delivery to one or more specified locations (e.g., via e-mail, fax, regular mail, courier, etc.) in any desired format (e.g., print, storage on electronic media such as CD-ROM, etc.) for the user and/or provider to obtain.

Electronic Currency

In one embodiment of the building management system, the user, provider and/or second interface employs electronic currency. Electronic currency (also known as electronic cash, digital currency, digital money or digital cash) refers to money, which is exchanged only electronically. Electronic currency is also meant to include credit card transactions. Typically, this involves use of a digital stored value systems on the database.

In various embodiments, one or more smart cards are employed. A smart card is a card-like device that is held close to or contacts (e.g. inserted, swiped touched, scanned, etc.) the user, provider and/or second interface and/or control device read by the interface. Smart cards also include “pay pass” cards, which are equipped with a radio-frequency chip that allows user to pay for purchases by simply waving their cards at readers posted at each user, provider and/or second interface. This smart card will have the capacity to be electronically written on at a point of sale terminal or interface, user and/or provider interface to record any type of transaction.

In various embodiments, the smart card is adaptable to readable and writable at conventional terminals (point of sale terminals), such as, for example credit/debit card terminals or other interfaces that allows the user to access the building management system and, for example, send information to a provider about a consumable, view transactions, view bill payment or invoice archives, make a payment, order a delivery of the consumable, etc. A second interface or computer can readily interpret this information. The smart card can also have the transaction recorded on its computer readable and/or writable data storage.

The smart card provides information to the interface, for instance, the smart card enables it to locate the data and computer programs necessary to re-create the user and/or provider's interaction that was terminated at the previous interface. The smart card interacts with the building management system and allows the user, for example, to view consumable information from a remote location, order a consumable, pay a bill, schedule an appointment, record a transaction or allows the provider to deliver a consumable, receive authorization so that the consumable can be delivered, exchange money, etc. In various embodiments, the smart card is encoded with personal and credit information. Each provider uses his/her respective card to obtain payment at an interface. In this way, the user does not have to release any personal and confidential information. The smart card can also be tied to a pre-selected source of funds such as a bank account, a credit card, a debit card, and/or a cooperate account, etc. The building management system eliminates the possibility of lost paper bills, cash, checks, etc. Essentially the building management system eliminates the need for cash transactions.

The smart card allows the user to access information from the home or building manager when the smart card is read at the interface. In various embodiments, it allows providers to encode transactions on card for documentation or transactions or consumption. It also allows the user to review recorded transactions (e.g., bill payment) and can be used as a receipt for such payment. The smart card allows the user and/or provider to enter the building management system at remote interfaces (e.g., remote system interfaces installed at locations other than the home) and access functions permitted by the home or building management system. For example, different smart cards can be given to different providers (e.g., oil company, pizza shop, pool company, etc.). The smart card can have a value associated with it and the provider upon delivery of the consumable to the home can have the card read (e.g., swipe the smart card) at the second interface and receive authorization from the home or building manager to approve delivery of the consumable (e.g., pizza) and charge the user's account.

In various embodiments, the building management system automatically: i) orders the consumable from the provider and/or ii) notifies the user as to a scheduled date of delivery of the consumable and/or iii) bills the user for the consumable and/or iv) pays the provider with electronic currency.

### EXAMPLES

The following examples are prophetic examples and are not intended to limit the scope of the present invention in any way.

### Example 1

### Smart Card

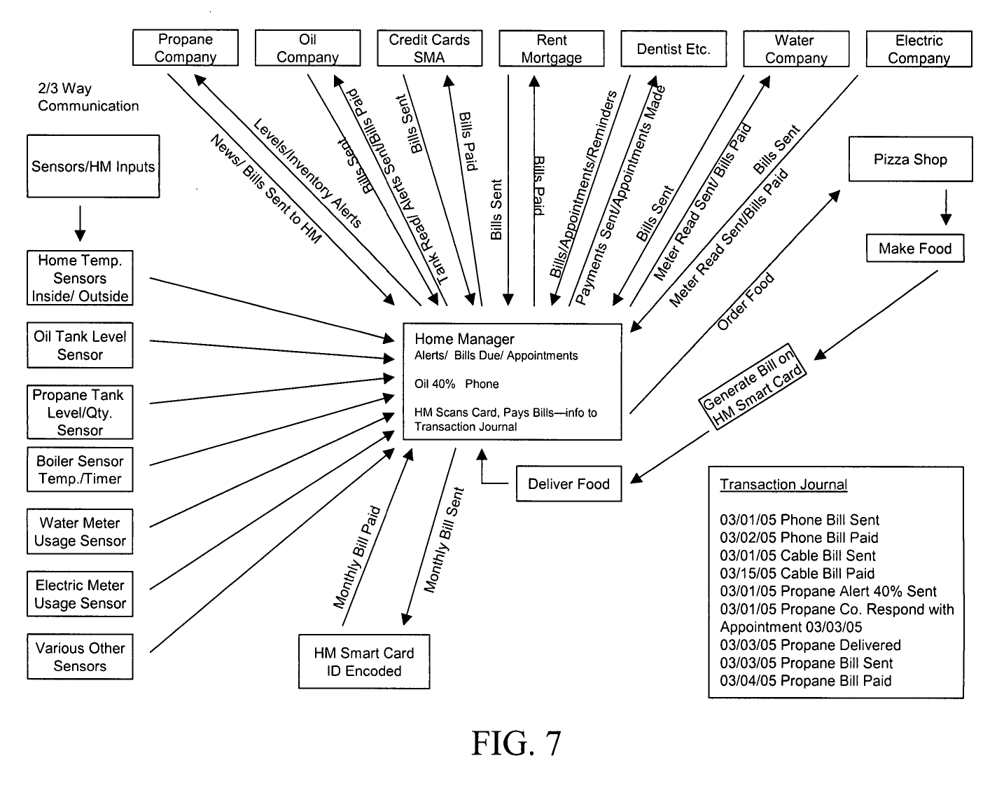

The inventive system as shown in FIG. 7, uses a smart card distributed to a user, which can communicate with numerous providers (e.g., vendors/payees). The smart card is encoded with personal and credit information. Each provider uses his respective card or hardware/software/system to obtain payment at a system interface. The home management system interface is usually installed at the user's home. So, for example, a restaurant delivering food would use its smart card at the user's home system interface upon delivery to have funds transferred electronically to its own account. In this way, the user does not have to release any personal and confidential information. The payee only sees “who” purchased and the payers information only can be interpreted by the credit card company. FIG. 1 shows that the home management system can be used with a variety of vendors, provide information regarding: appointments, consumables and bills as well as make payments of bills. The home manager can generate various reports including daily transactions.

The user can access account information or facilitate transaction via the smart card at remote system interfaces (e.g., remote system interfaces installed at locations other than the home) and at the user's home. At the system interface, using the smart card, the user can access as many functions as the system has allotted to the smart card.

### Example 2

### Bill Payment

The home management system can be formatted to accept information from different types of vendors and payees, to make purchases and bill payments, to issue reminders of bill payments or late reminders/alerts, to make ordinary sales transactions such as cash-on-delivery, in-home delivery (e.g., pizza delivery), etc. Vendor(s) refers to any person, company, organization, computer or the like that communicates by sending information to the system or receiving information from it.

The transactions are facilitated by the use of a smart card and a second interface (e.g., smart card interface (card scanner, reader, and/or writer) at the point of transaction that reads the vendor's smart card encoded with vendor identification and billing information. Transactions are thus made easier, safer, and more accurate due to the timely presentation and confirmation of information. The system eliminates the possibility of lost paper bills, cash, checks, credit cards, etc. Essentially the system eliminates the need for cash transactions.

The home management system smart cards can also be specifically encoded with customer information, thus making access to the system and its information secure and accessible from a remote location. The card is encoded with necessary data such as biographical data and/or authorization information. The card can also be tied to a pre-selected source of funds such as a bank account, a credit card, a debit card, a cooperate account, etc, and thus act as an identification (ID) and a payment method. The card can be initially “swiped” at an interface or other similar information gathering technology device that will authorize use of the system.

System terminals (user, second and/or provider interfaces) will have the dual capability of both reading and writing to both the system cards (e.g., smart card, credit card, a debit card) and thus obviate the necessity of requiring specialized terminals, as existing terminals may be used. Moreover, this will eliminate time-consuming data entry, increase accuracy, and eliminate fraud. This will also allow anonymity to the user and the ability to pay via approved payees or temporary authorizations.

Smart card holders can remotely access system information and transactions. This feature is especially valuable for people with second homes since it gives them the ability to monitor and timely respond to information and problems. The smart card can also be used as a debit card to pay for things at the point of service (POS).

### Example 3

### Home Inventory

This aspect of the home management system incorporates sensors located throughout the home or site that will relay information via a wired or wireless network (e.g., Bluetooth, wi-fi, cellular, etc.) to the system. The system gathers the information, analyzes it, and presents it at a central location. In addition pertinent information can be sent directly to vendors. Other benefits, with respect to home inventory from a vendor's perspective, include the elimination of tank level guesswork and man-hours spent filling tanks that are not completely empty, and the prevention of utility shortages from a tank being depleted. For example, a user would be informed of a low oil level in the user's oil tank and can automatically order and/or pay for the fuel. The fuel can then be delivered and a delivery-person can use his own smart card to receive payment. Furthermore, the system will eliminate the need for a meter reader, not only for the electrical company but also the municipal water company, thus saving these companies money and increasing efficiency and the accuracy of bills, as the bills would not have to be estimated but would reflect actual usage. Interpretation can vary from the system's configuration and can be set up with different parameters, either pre-programmed or end-user set at different inventory levels.

Sensors include but are not limited to the following:
Oil Tank Sensor: for measuring and relaying the level of oil in the oil tank, the system gathers information from an oil tank sensor(s) such as the one manufactured by Centeron™ and may optionally display tank status on a display screen. For example, the display screen would read “Tank is 50% capacity.” This data will then be interpreted by the system and/or the user and appropriate action can be taken by either or both the user and the system.

Propane Tank Sensor: for measuring and relaying the level in the propane tank, the system gathers information as the one manufactured by Centeron™ from a propane tank sensor and may display tank status on screen depending upon settings. For example, the system may display on the display screen “Tank is 50% capacity.” This data will then be interpreted similarly to the example above. Moreover, the system can include a gas sensor to warn the user of the presence of dangerous gases in the user's house. For example, the system can include a carbon monoxide and/or a propane gas-warning sensor. Furthermore, upon activation the system can respond as desired (e.g., automatically open windows, activate pumps, inform emergency personnel, etc.), as desired.

Boiler Sensor: for monitoring the temperature in the boiler, and when and how long the boiler has run, the system gathers this information for interpretation. This information can then be interpreted and the system can respond accordingly. For example, if the boiler has run for an unusually long period of time and the temperature in the house has not increased substantially (or if the system senses an open window) the system can lower the thermostat's temperature setting, deactivate heat to the particular zone in which the window is opened and/or turn off the boiler completely. It may also indicate a need to service or repair a boiler (i.e. cold weather—boiler not running).

Temperature Sensors: for measuring interior and exterior temperatures. The system gathers information from all sensors for interpretation, and may be integrated into heating/cooling systems.

Electric Meter Sensor: for reading kilowatt hours or other energy measuring units from meter and relaying this information wirelessly or using a wires to the system

Water Meter Sensor: for reading gallons or other units of measure from the meter and relaying this information wirelessly or wired to the home management system for interpretation and for other uses (e.g., paying for water usage). Moreover, the system can also activate optional electronically controlled valves to limit water usage. For example, if the system senses that a boiler has failed, the system can shut both the gas and water to the boiler to prevent a possible fire and/or flood.

Miscellaneous Sensors: for gathering information about materials/products/foods/solar and wind powered electricity, consumed in a household and relaying them to the system.

### Example 4

INTERPRETATION: Interpretation by the system can involve any number of sensors and inputs and can be programmed to respond at certain specified intervals. Examples:

Oil tank: level 40%. The home management system can interpret and relay this information in several ways by communicating directly with the oil company to deliver oil, by displaying an on-screen warning message to order oil, or other responses. For example, the system is set up to call the oil company automatically when the oil tank level is at 50% capacity. In one embodiment, when the oil tank falls to 40% of capacity the oil company is notified of the 40% status, and responds to the system with a delivery date, time, and price. An alternative response would be that the system is set up to notify the system user that oil tank is 40% full, and the user can determine action.

Propane Tank: In one embodiment, when the propane tank is at 30% capacity, the system can interpret and relay this information in several ways by communicating directly with the propane company to deliver propane, or by displaying an on-screen warning reminding the system user (predetermined parameters will the control on-screen warning) to order a propane delivery or some other response. Additionally, as discussed above, if there is a leak in the propane system (e.g., in the tanks, lines, appliances), the system can respond appropriately.

Temperature sensors/oil tank level/boiler sensor: the system can monitor various sensors and respond appropriately. For example, if the sensors read as follows:
Outside temperature: 25° F.
Interior temperature: 45° F.
Oil Tank: 50% capacity
Boiler temperature: 5020 F.
Electricity available
   and the system's parameters for boiler temperature are defined in the normal range as 180-220° F. The boiler temperature of 50° F. falls outside normal parameters, indicating to the system that the boiler is not functioning. That system will perform a diagnosis, which can eliminate possible variables such as oil availability, electricity to house, etc. In this case, it will determine that there is still fuel and electricity present, and interpret this as a boiler malfunction, and can contact the service company with this information so a service person may be sent to service the system, as opposed to ordering oil.

Water sensor: the water sensor senses water usage. In one embodiment of the present invention, if the system senses a constant flow of water, which is inconsistent with normal usage in the home, the system performs a diagnosis to determine why there is an abnormal water flow. For example, the system could determine whether a hose was left on, whether a toilet is running, etc. and can alert the occupants of the house on screen (either in the house or in a remote location, e.g., PDA, blackberry, etc.) to check possible causes. The system can also be set up to notify a plumber (e.g., Mr. Plumber at (000) 000-0000). In alternative embodiments, it is also envisioned that the system can use voice recognition software or a prerecorded message (e.g., a digital message, etc.) to alert the plumber using a standard telephone system, or it can send a digital message.

### Example 5

### Message Board/Display Screen

This screen displays pertinent information on-screen such as alerts from the interpretation of sensors, bills from vendors, or ALERTS or REMINDERS sent to the system from individuals, companies, or organizations with whom the system consumer deals, which may include but are not limited to the following:

Electric Bill DUE (DATE) PAY BILL? CLICK HERE? CURRENT BILL DUE XX/XX/2005. LAST MONTH'S BILL $250. PAYMENT RECEIVED: $250. NEW AMOUNT DUE: $220. TOTAL DUE: $220? PAY BILL NOW? YES/NO? WHICH FORM OF PAYMENT WOULD YOU LIKE TO USE? SMART CARD/CREDIT/DEBIT/ONLINE CHECK? SCAN CARD? AUTHORIZE/VERIFY? $220 PAYMENT SENT XX/XX/2005. RECEIPT SENT TO TRANSACTION JOURNAL.
Phone Bill DUE(DATE) PAY BILL? CLICK HERE (see above)
Propane Bill DUE (DATE) PAY BILL? CLICK HERE(see above
Oil Bill DUE/(DATE) PAY BILL? CLICK HERE(see above)
Cellular Phone Bill (DATE) PAY BILL? CLICK HERE(see above)
Dentist Bill DUE (DATE) PAY BILL? CLICK HERE(see above)
Pool Service Bill DUE (DATE) PAY BILL? CLICK HERE(see above)
DENTIST APPOINTMENT Feb. 25, 2005 3:00 PM!!!
AUTOMOBILE: CHEVROLET SERVICE APPOINTMENT 3/1/05 CAR MUST BE DROPPED OFF BY 8:00 AM DAY OF SERVICE. THANK YOU: JOEYS CHEVY 2143 PARK HIGHWAY . . . (PHONE #)

As a bill due date draws near (e.g., a payment date nears as optionally defined by user default setting) a bill or bill icon can be made to change appearance to communicate a degree of urgency.
EXAMPLE: 1 week to pay icon/bill flashes 24 HOURS: Icon is sized such that it is displayed on 75% of screen and flashes.
PAY BILL SCREEN:

Information is gathered from vendors and can be displayed on the system screen. If bills are selected to be automatically paid by the smart card, debit cards, credit cards, online checks or other methods, receipt or icons will appear on screen, and complete bills can be viewed on screen. For example:
Oil Bill: Jan. 25, 2005 Oil delivered Jan. 25, 2005 Delivery truck filled 540 Gallons at $1.65 per gallon for a total of $891.00. Past Due % 0 total DUE $891.00
PAY $891.00 Yes/No
Yes: swipe the system card:
Card type the system card: Authorized user MR. Home AUTHORIZED
Swipe Payment card: credit/debit/check
Authorize Payment of $891.00
Sign the system (SIGNATURE) on screen touch pad.
Payment Feb. 27, 2005 paid $891.00

### Example 6

Point of sale (POS) transactions outside and inside home: smart card can be used as a debit card if so set up. In a taxi: taxicab is set up with POS terminal, at end of ride fare is generated on screen at POS and paid for via the system card (e.g., smart card, bank account, a credit card, or a debit card). A pin number can be used. There may or may not be a name on card and only the system knows who just used the card. This system then would keep track of all bills so that the user can see the exact nature of the payment. This can also be useful for businesses and for tax purposes. For example, the system's user can, in a matter of minutes, generate a complete list of tax-deductible expenses for a given time period (e.g., a year). This can reduce guesswork and paperwork, and increase accuracy.

### Example 7

TRANSACTION JOURNAL: Transactional journal keeps a record by date and time, and by category and vendor of all ALERTS sent and received, and all payments sent and received. It is a running journal and a verification of transactions. (An example of an alert is shown in FIG. 4 and an example of a transaction log is shown in FIG. 12). This will allow the system user to prove or verify actions taken, and payments made by him. Entries will be archived periodically as predetermined by the system user. See above example.

### Example 8

### Home Manager Information Exchange

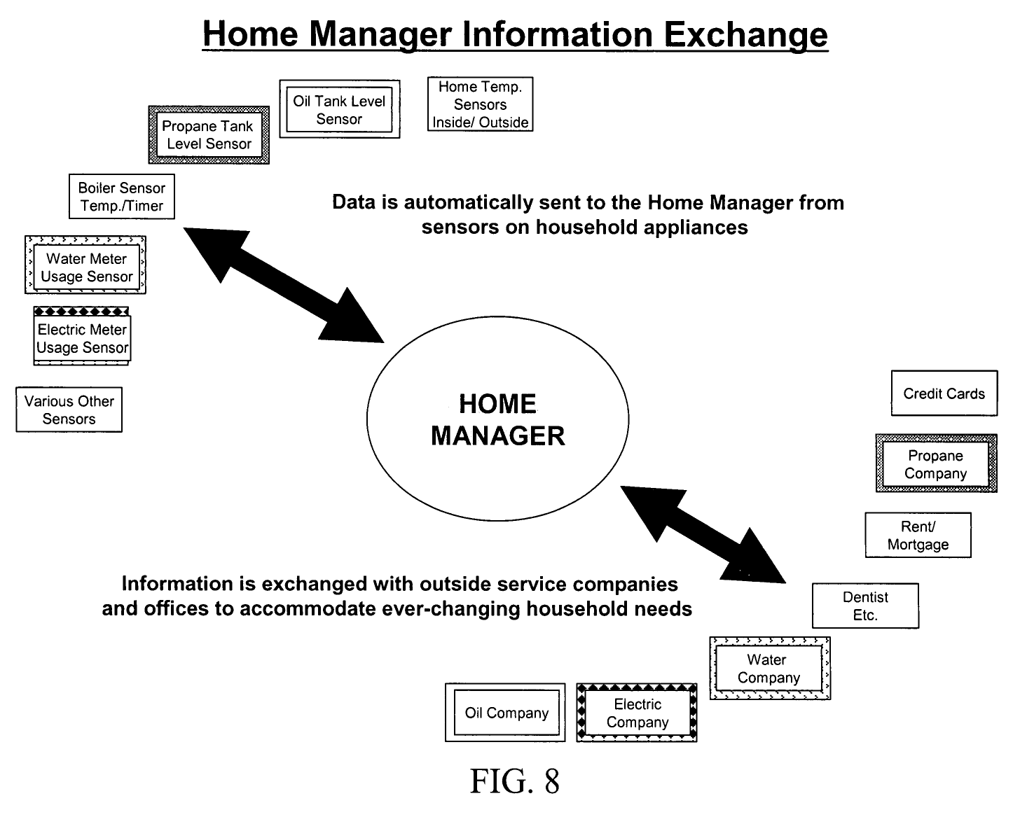

The home manager is a device that allows people to at least monitor household appliances, utilities, and vital inventory levels of fuels consumed in the home. It relays pertinent information to service companies, and facilitates bill payment via a touch screen in the home. The home manager integrates a series of sensors in and around the home with service companies through a processor and digital point of sale/credit card terminal incorporated into the home management system. This allows the operator to swipe their credit or debit card or smart card to pay bills without the hassle of paperwork and checks, thus improving security and efficiency. The home manager can be customized to fit the desires of individual homes and businesses. It can be set to be fully automated, conducting daily maintenance, correspondence, and bill payment on its own. Or, the home manager can be set to require confirmation from the operator before every interaction with outside businesses. The home manager is a versatile instrument that can be adapted to incorporate new technology, new appliances, and billing transactions with all companies large or small. FIG. 8 illustrates the information path in one embodiment of the home manager. Information about the consumable flows from the control device (e.g., a sensor) to the home manager where the information can be sent to various providers.

### Example 9

### Information Path for Deliverable Consumable

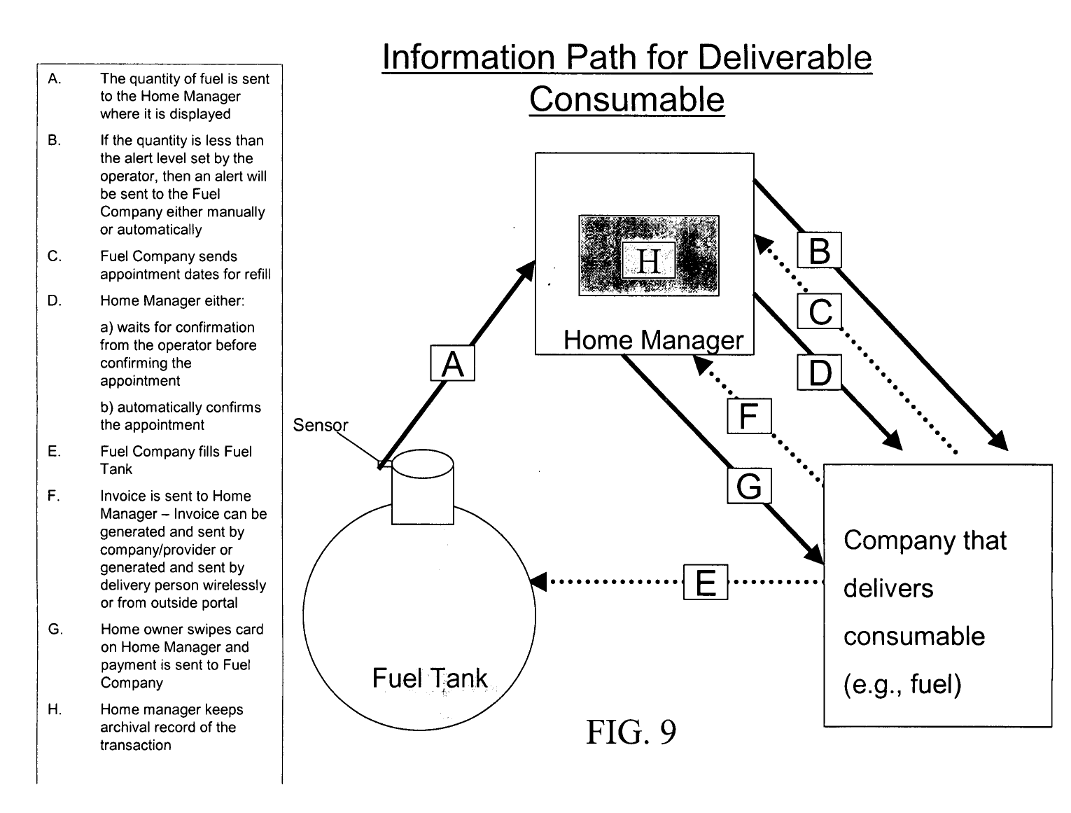

FIG. 9 illustrates the information path in one embodiment of the home manager. Information about the deliverable consumable (e.g., fuel consumption) is displayed on the user interface of the home manager. When the control device (e.g., sensor) detects low fuel, a notification is sent to the fuel company and the fuel company replenishes the fuel. An invoice is sent to the home manager and the user can make payment utilizing the home manager. Path A in FIG. 9, illustrates the quantity of fuel information that is sent from the sensor to the home manager where it is displayed at an interface. Path B illustrates if the quantity is less than the alert level set by the operator, then an alert will be sent to the fuel company either manually or automatically. Path C illustrates the path where the fuel company sends appointment dates for refill to the home manager. Path D illustrates the functions where the home manager either: a) waits for confirmation from the operator before confirming the appointment or b) automatically confirms the appointment. Path E illustrates where the fuel company fills the tank and Path F illustrates the path where an invoice is sent to the home manager. The invoice can be generated and sent by the provider or generated and sent by a delivery person wirelessly or from an outside interface. Path G illustrates where the homeowner swipes card on home manager interface and payment is sent to a fuel company. The home manager can store and archive the transaction on the database shown as Path H.

### Example 10

### Information Path for Companies Without Sensors

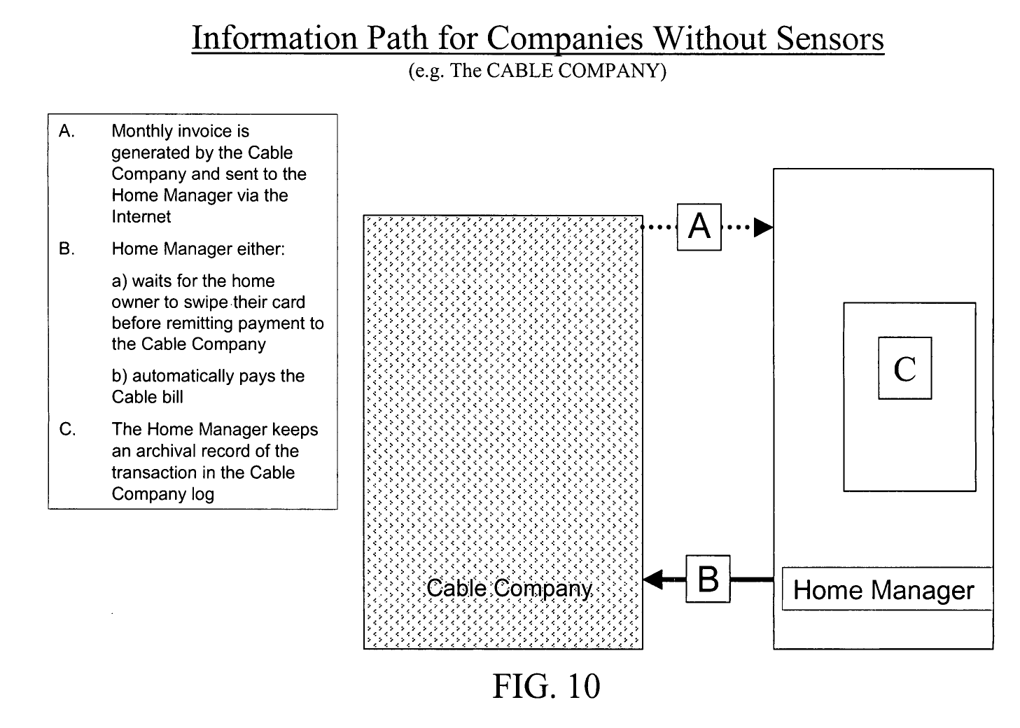

FIG. 10 illustrates the information path in one embodiment of the home manager when the consumable does not have a control device (e.g., a sensor) coupled to the home manager. The information regarding the consumable can be sent by various providers (e.g., cable company) to the home management system. In Path A, a monthly invoice is generated by the cable company and sent to the home manager via the Internet. Path B illustrates functions where the home manager either: a) waits for the homeowner to swipe their card before remitting payment to the cable company or b) automatically pays the cable bill. Path C illustrates where the home manager keeps an archival record of the transaction in the cable company log.

### Example 11

### Information Path For Low Maintenance Utilities or Appliances

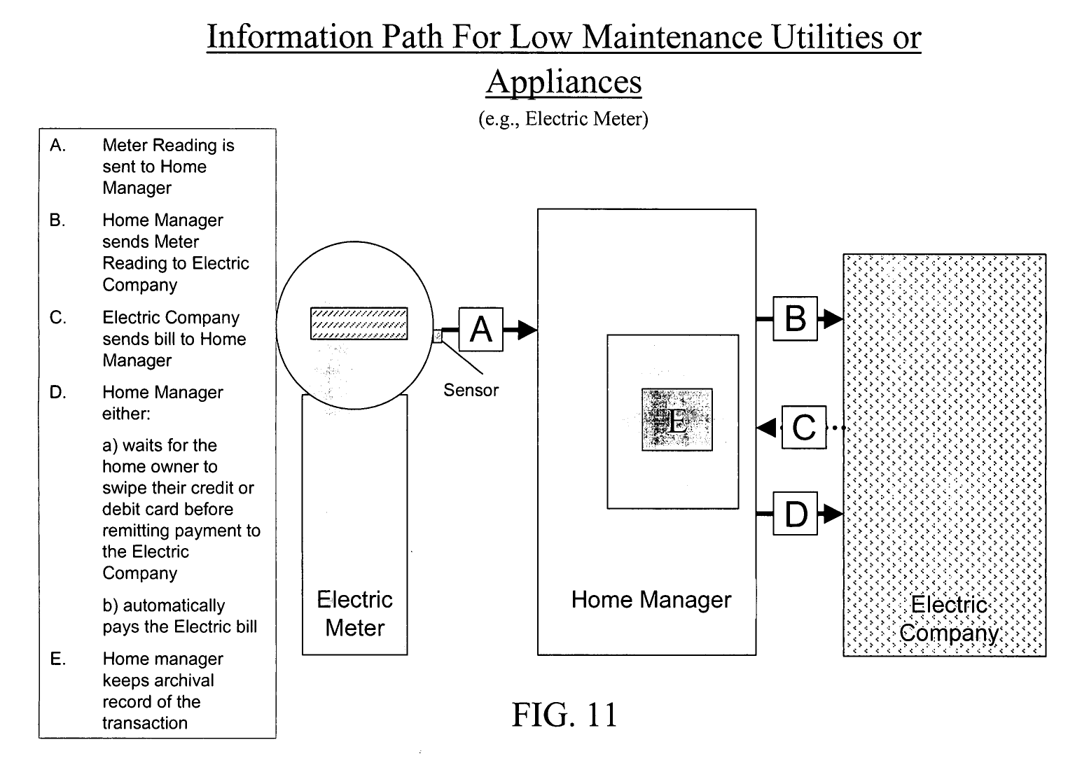

FIG. 11 illustrates the information path in one embodiment of the home manager. Information about the low maintenance consumable (e.g., electric meter) is displayed on the user interface of the home manager. When the control device (e.g., sensor) sends a meter reading to the home manager, the homeowner has the option to pay the bill using the home manager. Path A illustrates meter reading information that is sent to home manager. Path B illustrates the home manager sending the meter reading to the electric company. In Path C, the electric company sends the bill to the home manager. The home manager either: a) waits for the homeowner to swipe their credit or debit card before remitting payment to the electric company or b) automatically pays the electric bill. The home manager can store and archive the transaction on the database shown as Path E.

### Example 12

### The Home Manager Log in Conjunction with Household Functions and Alerts

The home manager records include information that passes through it in a digital log. This log helps the home manager to get to know it's location and services to better assist the operator (FIG. 12 shows a typical log). For example, by recording and analyzing usage of fuel, electricity, and water, the home manager will be able to determine if there is unusual activity. If unusual activity is identified, such as high rates of fuel consumption, the home manager will be able to alert the operator that there is a problem with a boiler, heater, or a water or fuel leak because it can extrapolate current usage with past data to determine if there is a problem. (FIG. 4 shows a typical alert). When a new appliance or household system is installed, the home manager will be able to tell the operator how it affects the other systems in the home. For example, if a new insulation is installed, the home manager will be able to determine how efficient it is based on changes in heating and air conditioning costs. Likewise, if a more fuel-efficient heater is installed, the home manager will be able to determine how much fuel is being saved, and how this translates this into dollars.

### Example 13

### Home Manager Remote Access and Security Features

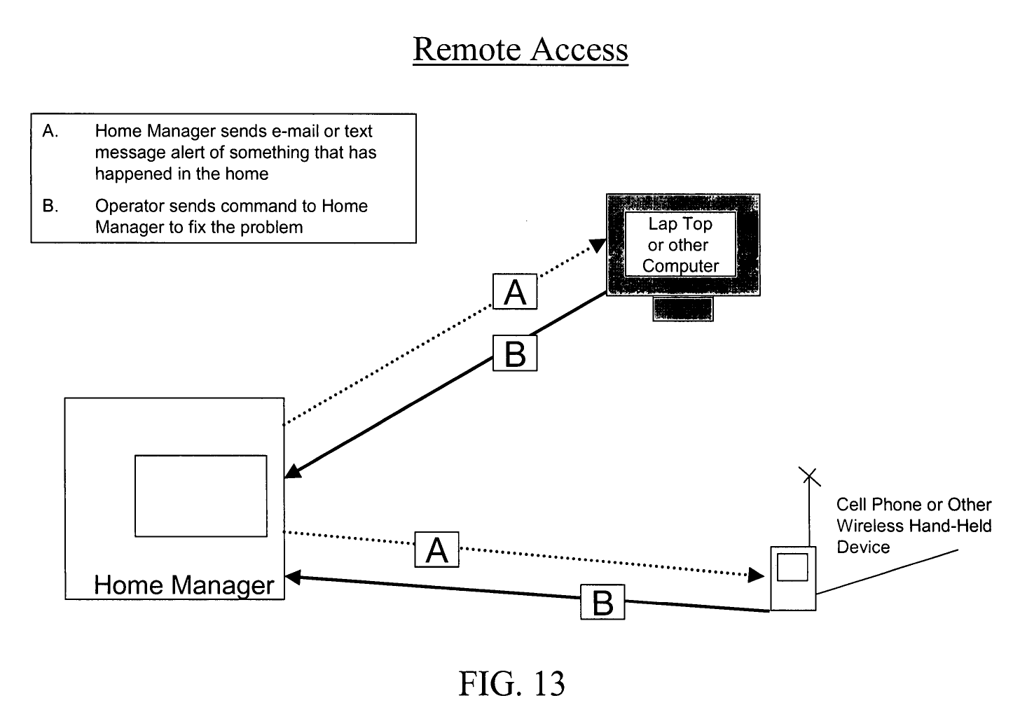

FIG. 13 illustrates the home manager sending information about the consumable to a remote user or provider interface, which allows the user or provider to send a command to other parts of the home manager. The user does not need to be physically present to use the home manager. The home manager can be accessed remotely via the Internet with a home computer or handset with Internet capabilities or other wired or wireless technology. The home manager acts as a server from which information can be downloaded or uploaded. The home manager can be programmed to send e-mail alerts to the operator while they are away on vacation, or in case of an emergency while outside of the home.

For security purposes, the operator may enter a personal identification number or other security identifier in order to access the home manager remotely. This password is optional for in-home use, as the operator sees fit. The home manager can be programmed to support multiple users each with access to features dictated by the operator.

In various embodiments, the home manager provides increased safety, security and convenience to a user. Moreover, the home manager is ideal for people who have multiple residences such as a summer home, a winter home, a townhouse, a vacation home in a different country etc., who wish to monitor and pay bills, monitor appliances, temperatures, etc. and optionally perform a desired action.

It will be apparent to those skilled in the art that various modifications and variations can be made to various embodiments described herein without departing from the spirit or scope of the teachings herein. Thus, it is intended that various embodiments cover other modifications and variations of various embodiments within the scope of the present teachings.

What is claimed is:

1. A computer based building management system for managing a consumable, the system comprising: a user interface that displays options for a user to view some or all information about the consumable and manage the consumable,
a database coupled to the user interface for storing some or all information about the consumable to manage the consumable;
a processor coupled to the user interface and the database, the processor to receive and send information about the consumable to the database and the user interface;
a provider interface coupled to the processor to send and receive an order from the user interface; and
a control device that monitors the use of the consumable by sending information about the consumable to the processor.

2. A system according to claim 1, wherein the provider interface comprises a provider database and a provider processor to receive and send information about the consumable to the database, processor and/or user interface.

3. A system according to claim 1, wherein the processor is configured to request identification from at least one user and/or provider to verify authorization to submit or receive an order.

4. A system according to claim 1, wherein the building management system is used to manage a plurality of consumables in a plurality of homes.

5. A system according to claim 1, wherein the control device is a sensor and the consumable is at least one of oil, gas, electric, temperature, cable, and water.

6. A system according to claim 1, wherein the system further comprises a second interface coupled to the processor, wherein the user can authorize or the provider can receive authorization to replenish the consumable at the user's home.

7. A system according to claim 5, wherein the second interface comprises a card swipe for the provider to receive or decline authorization to replenish the consumable.

8. A system according to claim 1, wherein the processor employs a network based server to receive and send information about the consumable to the user and/or provider.

9. A system according to claim 1, wherein the processor employs the Internet to receive and send information about the consumable and order the consumable.

10. A system according to claim 1, wherein the user interface and/or the provider interface displays options for the user or provider to view consumable quantity, consumable usage, consumable usage pattern, and/or expenses of the consumable.

11. A system according to claim 1, wherein the user interface and/or the provider interface displays an alert when usage of the consumable is at predetermined level as detected by the control device.

12. A system according to claim 1, wherein the processor can start, stop, increase and/or decrease the usage of the consumable.

13. A system according to claim 1, wherein the processor sends an alert to the user or provider by e-mail, phone, text message, pager, and/or fax.

14. A system according to claim 1, wherein the system comprises at least one user and/or provider interface that is wireless and/or remote or wired.

15. A system according to claim 1, wherein the provider interface is configured to send and receive authorization to pay a bill and/or send an invoice to the user interface.

16. A system according to claim 1, wherein the provider interface is configured to send and receive electronic currency from a user's credit card, debit card, and/or smart card.

17. A system according to claim 1, wherein the provider or user interface is configured to set usage of the consumable to a predetermined level.

18. A system according to claim 1, wherein the system automatically: i) orders the consumable from the provider and/or ii) notifies the user as to a scheduled date of delivery of the consumable and/or iii) bills the user for the consumable and/or iv) pays the provider with electronic currency.

19. A system according to claim 1, wherein the system allows the user interface to generate reports concerning past usage and/or bill payments for the consumable.

20. A computer based building management system for managing bills and/or appointments, the system comprising: a user interface that displays options for a user to view some or all information about the bills and/or appointments,
a database coupled to the user interface for storing some or all information about the bills and/or appointments; and
a processor coupled to the user interface and the database, the processor to receive and send information about the bills and/or appointments to the database and the user interface; and
a provider interface, the provider interface coupled to the processor to send and receive information about the bills and/or appointments to and from the user interface so that the user can manage the bills and/or appointments; wherein the user and/or the provider interface displays an alert as to a deadline for bill payment and/or appointment.

21. A system according to claim 20, wherein the processor assigns at least one user an appointment and/or bill.

22. A system according to claim 20, wherein the processor prioritizes the bill and/or appointment based on the deadline.

23. A system according to claim 20, wherein the processor automatically schedules the appointment and/or bill payment.

24. A system according to claim 20, wherein the user interface displays an alert when an appointment and/or bill payment becomes due.

25. A system according to claim 20, wherein the processor is configured to request identification from at least one user and/or provider to verify authorization to access the system.

26. A system according to claim 20, wherein the user interface is configured to allow the user to pay a bill.

27. A system according to claim 20, wherein the system comprises a second interface, which comprises a card swipe for the provider or user to receive authorization for bill payment and/or to set the appointment.

28. A system according to claim 20, wherein the processor employs a network based server to receive and send information about the bills and/or appointments.

29. A system according to claim 20, wherein the processor employs the Internet to receive and send information about the bills and/or appointments.

30. A system according to claim 20, wherein the processor sends an alert to the user or provider by e-mail, phone, text message, pager, and/or fax.

31. A system according to claim 20, wherein the system comprises at least one user and/or provider interface that is wireless and/or remote.

32. A system according to claim 20, wherein the provider interface is configured to send and receive electronic currency from a user's credit card, debit card, and/or smart card.

33. A system according to claim 20, wherein the system allows the user interface to generate reports concerning past bill payments and/or appointments.

34. A smart card comprising: a computer usable medium having computer readable and/or writable program code embodied therein configured to identify a user and/or provider at a user or provider interface of the system according to claims 1 or 20.

35. A smart card according to claim 34, wherein the computer readable code is further configured to transfer electronic currency.

36. A smart card according to claim 35, wherein the computer usable medium is configured for a particular provider or user and records the transaction and/or transfer of electronic currency or consumable.

37. A smart card according to claim 36, wherein the smart card records the electronic transfer.

38. A method for managing a consumable, comprising providing: a user interface that displays options for a user to view some or all information about the consumable and manage the consumable,
a database coupled to the user interface for storing some or all information about the consumable to manage the consumable;
a processor coupled to the user interface and the database, the processor to receive and send information about the consumable to the database and the user interface;
a provider interface coupled to the processor to send and receive an order from the user interface; and
a control device that monitors the use of the consumable by sending information about the consumable to the processor.

39. A method for managing bills and/or appointments, the method comprising providing:
a user interface that displays options for a user to view some or all information about the bills and/or appointments,
a database coupled to the user interface for storing some or all information about the bills and/or appointments; and
a processor coupled to the user interface and the database, the processor to receive and send information about the bills and/or appointments to the database and the user interface; and
a provider interface, the provider interface coupled to the processor to send and receive information about the bills and/or appointments to and from the user interface so that the user can manage the bills and/or appointments; wherein the user and/or the provider interface displays an alert as to a deadline for bill payment and/or appointment.

40. A system according to claim 1, wherein the building management system retrieves stored information concerning the consumable's past usage from the database, correlates the usage of the consumable to the usage detected from the control device and sends an alert to the control device, user interface and/or provider interface to stop the usage of the consumable.

41. A system according to claim 5, wherein the control device is coupled to the provider interface and sends the consumable information to the provider interface simultaneously, before or after the consumable information is sent to the database, processor and/or user interface.

42. A computer based home management system for managing a consumable, the system comprising: a user interface that displays options for a user to view some or all information about the consumable and manage the consumable,
a database coupled to the user interface for storing some or all information about the consumable to manage the consumable;
a processor coupled to the user interface and the database, the processor to receive and send information about the consumable to the database and the user interface;
a provider interface coupled to the processor to send and receive an order from the user interface; and
a control device that monitors the use of the consumable by sending information about the consumable to the processor.
a second interface coupled to the processor to send and receive an order from the user interface, the second interface requesting identification from the provider via a smart card, the smart card comprising: a computer usable medium having computer readable and/or writable program code embodied therein configured to identify a provider at a second interface and authorize delivery of the consumable.

43. A computer readable storage medium storing instructions that, when executed by a computer, cause the computer to display options for a user to view some or all information about a consumable and manage the consumable from a user interface by accessing a database coupled to the user interface, the database for storing some or all information about the consumable to manage the consumable; a processor coupled to the user interface and the database, the processor to receive and send information about the consumable to the database and the user interface; a provider interface coupled to the processor to send and receive an order from the user interface to manage the consumable; and a control device that monitors the use of the consumable by sending information about the consumable to the processor.
